(19) United States
(12) Patent Application Publication
(10) Pub. No.: US 2006/0273708 A1
(43) Pub. Date: Dec. 7, 2006

(54) Display device comprising a deflection unit and a deflection unit for a display device

(75) Inventor: Leendert J. Noordermeer, Eindhoven (NL)

Correspondence Address: LAHIVE & COCKFIELD, 28 STATE STREET, BOSTON, MA, 02109, US

(73) Assignee: L.G. Philips Displays, Eindhoven (NL)

(21) Appl. No.: 10/534,154

(22) PCT Filed: Oct. 28, 2003
(86) PCT No.: PCT/EP03/12072

§ 371 Date: Aug. 7, 2006

(30) Foreign Application Priority Data
Nov. 4, 2002 (EP) 02079603.3

(51) Int. Cl. H01J 29/46; H01J 29/50

(52) U.S. Cl. 313/441; 313/414; 313/409

(57) ABSTRACT

A colour display device comprising a cathode ray tube and a deflection unit. The display device includes compensation magnets for correcting a raster distortion in the raster displayed on the screen. Said magnets (25, 26) comprise a shunt (25a, 26a) to increase the temperature coefficient of the permanent remanence. Preferably overcompensation occurs, i.e. the temperature coefficient is changed from a negative to a positive value.

### BACKGROUND OF THE INVENTION

The invention relates to a colour display device comprising a cathode ray tube comprising a display screen, a means for generating at least one electron beam and a deflection unit for generating deflection fields for deflecting electron beam(s) across the display screen in two perpendicular directions and having permanent magnets in or near a display screen facing end of the deflection unit for generating a magnetic field to reduce raster distortions.

The invention also relates to a deflection unit for a cathode ray tube.

Such display devices and deflection units are known.

The known display devices comprise a number of raster magnets arranged around the defection unit and at the side of the deflection unit facing the display screen. The magnets correct a pin-cushion shaped distortion which would otherwise occur.

Although the known devices do substantially reduce raster errors especially in the corners of the display screen, there is an ever greater need for further improvement of the image.

It is an object of the invention to provide a display device and/or a deflection unit for a display device in which image rendition is improved.

To this end, in accordance with an aspect of the invention, the display device is characterized in that the permanent magnets are made of a material having a negative temperature coefficient for the magnetic remanence, said magnets being provided with a compensating shunt to increase the temperature coefficient of the magnetic remanence.

When “temperature coefficient” is mentioned in the present application the temperature coefficient at room temperature (approximately 20-25° C.) is meant, unless otherwise specified.

Apart from raster errors other image errors occur, in particular doming. Such errors negatively influence the image quality. Increasing the temperature coefficient (i.e. at least making it less negative) of the raster magnets has surprisingly shown to have a positive influence on doming, i.e. a reduction of overall doming occurs, which improves the image.

In embodiments the combination of magnet and shunt has a magnetic remanence which is substantially constant between room temperature and approximately 60° C. In such an arrangement the temperature coefficient in the indicated temperature range is substantially zero. By “substantially constant magnetic remanence” a change of less that 3%, preferably less than 2%, is meant. “Magnetic remanence” is the strength of the magnet after full magnetization, measured without external fields. A substantial doming reduction is achieved.

In preferred embodiments the combination of magnet and shunt has a magnetic remanence which increases as the temperature-increases from room temperature.

The inventors have realized that overcompensation of the temperature coefficient leads surprisingly to an even further reduction of doming.

In further preferred embodiments the magnetic remanence shows a maximum between 40 and 70° C.

### BRIEF DESCRIPTION OF THE DRAWINGS

These and further aspects of the invention will be explained in greater detail by way of example and with reference to the accompanying drawings, in which

FIG. 1 is a display device;

FIG. 2 is a sectional view of a deflection unit comprising compensation coils

FIG. 3 schematically shows the position of the permanent magnets 25, 26 in an exemplary embodiment.

FIG. 4 shows, in a graphical form, the temperature dependence of the magnetic remanence B(G) of magnets as a function of temperature.

FIG. 5 shows, in a graphical form, the doming behaviour as a function of time using various raster magnets.

FIGS. 6A and 6B show schematically magnets suitable for use in a device in accordance with the invention.

The Figures are not drawn to scale. In general, like reference numerals refer to like parts.

### DETAILED DESCRIPTION OF PREFERRED EMBODIMENTS

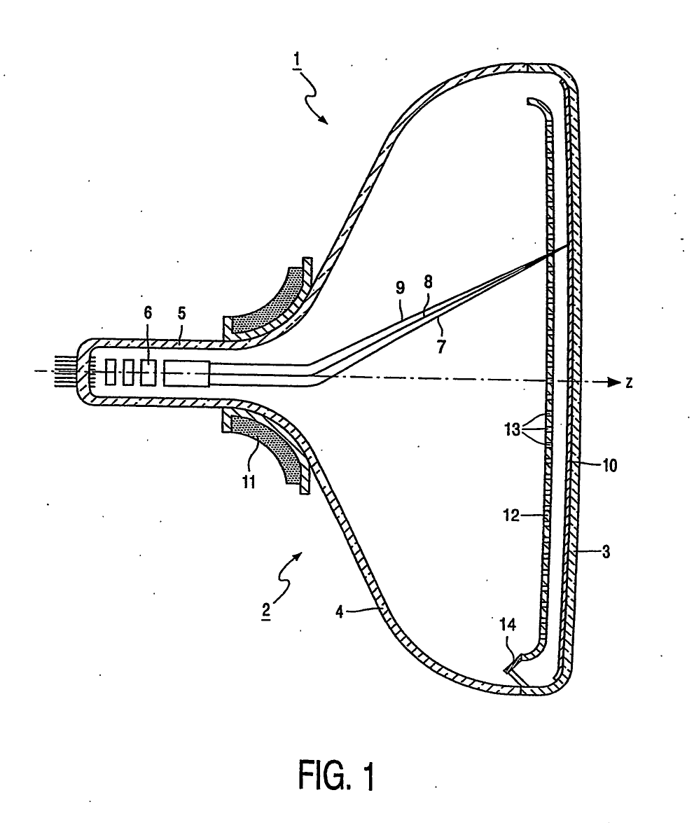

A colour display device 1 (FIG. 1) includes an evacuated envelope 2 comprising a display window 3, a cone portion 4 and a neck 5. In said neck 5 there is provided an electron gun 6 for generating three electron beams 7, 8 and 9. A display screen 10 is present on the inside of the display window. Said display screen 10 comprises a phosphor pattern of phosphor elements luminescing in red, green and blue. On their way to the display screen the electron beams 7, 8 and 9 are deflected across the display screen 10 by means of a deflection unit 11 and pass through a shadow mask 12 which is arranged in front of the display window 3 and which comprises a thin plate having apertures 13. The shadow mask is suspended in the display window by means of suspension means 14. The three electron beams converge on the display screen. They pass through the apertures of the shadow mask at a small angle with respect to each other and, consequently, each electron beam impinges on phosphor elements of only one colour. In FIG. 1, the axis (z-axis) of the envelope is also indicated.

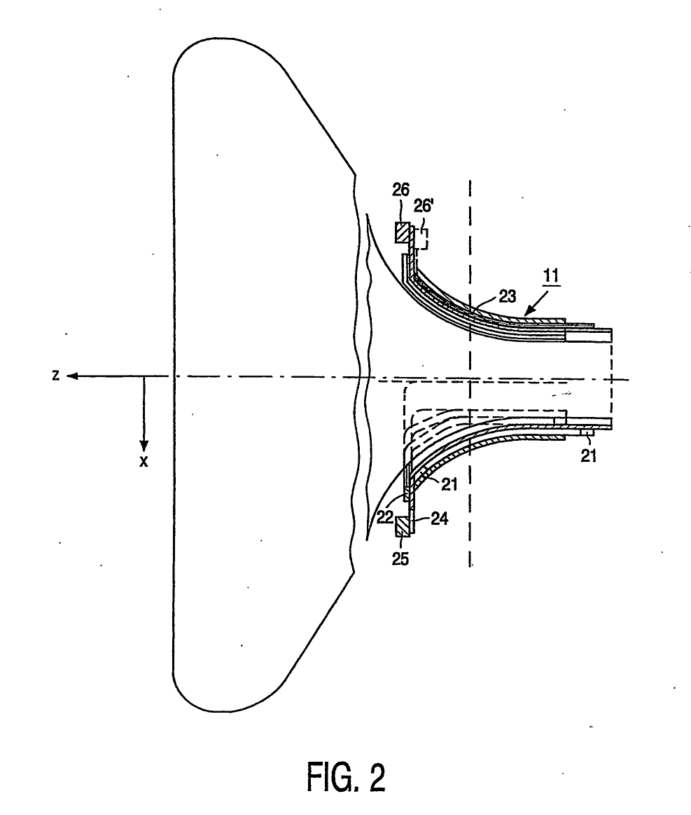

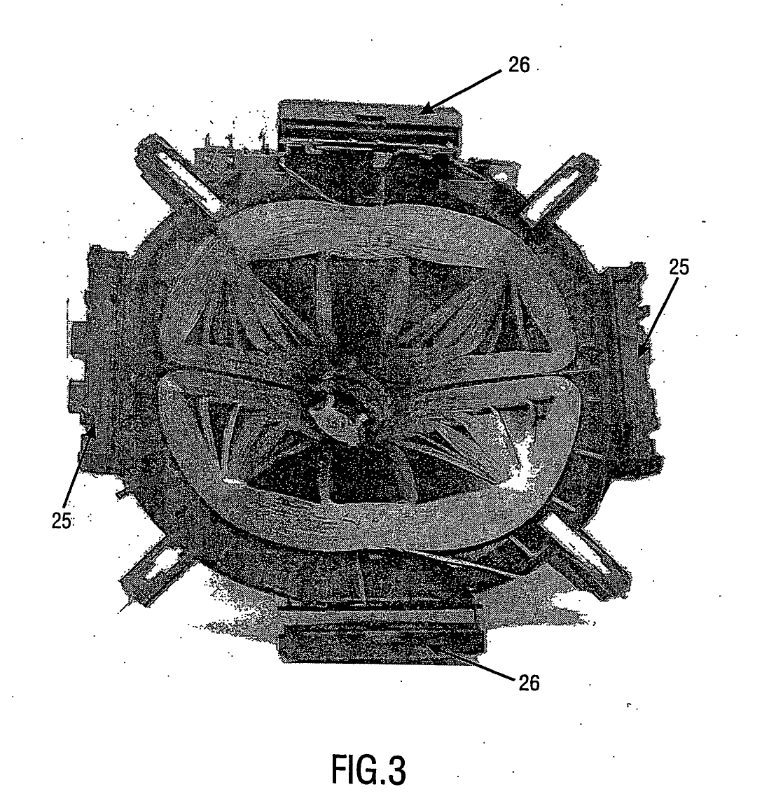

FIG. 2 is a sectional view of a deflection unit in accordance with the invention. Said deflection unit comprises two deflection coil systems 21 and 22 for deflecting the electron beams in two mutually perpendicular directions. Coil system 21 comprises coils for the field deflection (deflection at a relatively low frequency, which in standard devices is the vertical direction) of the electron beams. In this example, the deflection unit further comprises a yoke 23. Said yoke is made of soft-magnetic material. Correction permanent magnets 25, 26 are arranged around the display device, in this example on the deflection unit 11 at or near the side of the deflection unit (the flaring end) that faces the display screen. The correction magnets 26 may be fitted into a holder 24 or directly on the deflection unit. The magnets may be fitted on a frontal surface of holder 24 (i.e. a surface facing the display screen) or on a rearward facing surface (as shown in FIG. 2 by correction coils 26′). FIG. 3 schematically shows the position of the permanent magnets 25, 26 in an exemplary embodiment.

In many types of CRT's (Cathode Ray Tubes) permanent magnets are used for correcting the geometry (aster) of the picture. The most commonly used material is plasto-ferrite and hard ferrite. These materials have a magnetic remanence that decreases with increasing temperature. The temperature coefficient is typically −0.3%/° C.

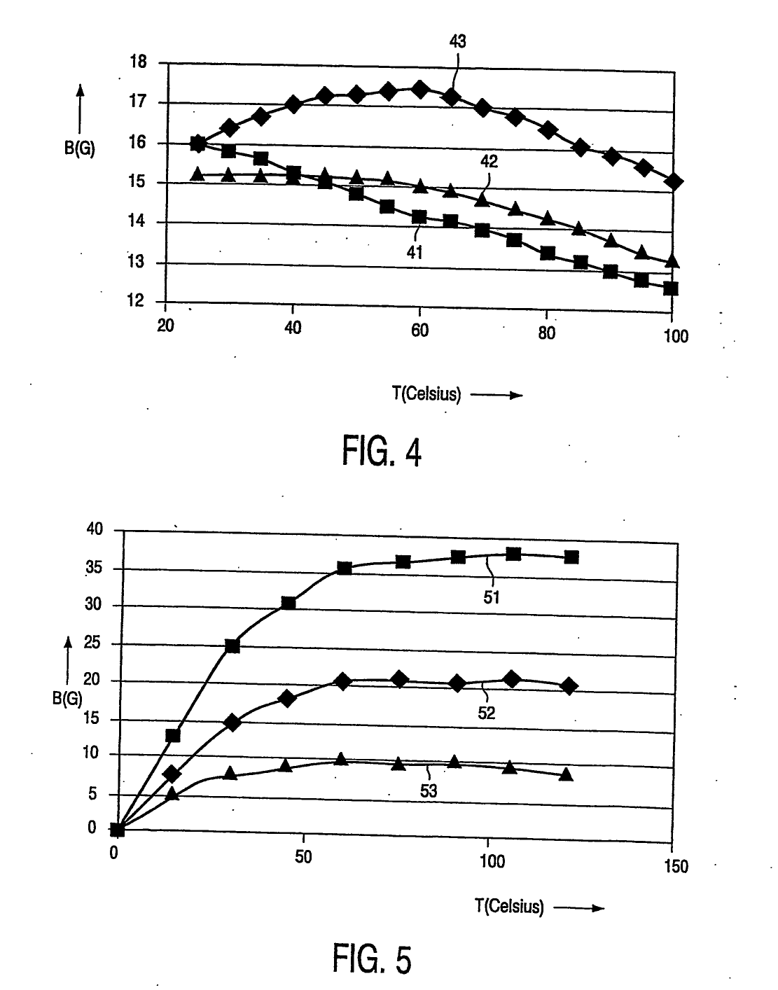

The inventors have realized that the permanent magnets also have an influence on landing. In some types the thermal behavior of the magnets contributes to the bad ambient doming performance. In order to improve this, magnets are used having a shunt to increase the temperature coefficient of the magnetic resonance. In embodiments thermostable permanent magnets are used. The ferrite magnet is e.g. shunted by a material (NiFe30) with a Curie temperature of 60°-90° C. By choosing e.g. a 10% stronger magnet and shunting 10% it is possible to stabilize the magnet from 20° to 60° C., i.e. making the magnetic remanence substantially constant. The ambient doming improves from e.g. 1.7 μm/° C. to 1.2 μm/° C. In preferred embodiments of the invention the decrease of the magnetic remanence of the permanent magnet is overcompensated e.g. by choosing a 20% stronger ferrite magnet and shunting 20% of the field. It has surprisingly been found that such overcompensation (i.e. increasing the temperature coefficient to a positive value) improves the thermal doming behavior to e.g. approximately 0.4 μm/° C. The thermal dependence of the permanent remanence (B(G)) as a function of temperature for a standard magnet (line 41), a nominally compensated magnet (e.g. a 10% shunted magnet) (line 42), and an overcompensated magnet (e.g. a 20% shunted magnet) (ine 43) can be seen in FIG. 4. For the standard magnet the magnetic remanence decreases as the temperature increases, for the nominally compensated magnet, the magnetic remanence is constant between approximately 20 and 60° C., after which it drops, for the overcompensated magnet the magnetic remanence increases (i.e. showing a positive temperature coefficient), reaches (in this preferred embodiment) a maximum (of approximately 8% above the permanent remanence at room temperature) around 55-60° C., after which it drops. It is preferred that the permanent remanence shows a maximum between 40 and 70° C., which is preferably between 5 and 12% higher than the permanent remanence at room temperature. Too high an overcompensation will again increase doming.

When the landing during 2 hours of warming up is measured, the improvement is clearly visible. FIG. 5 shows the doming displacement (vertical axis) in μm, as a function of time in minutes (horizontal axis). The doming displacement is a measure of the displacement of the beams on the screen as the CRT heats up. The larger the displacement, the larger the image errors associated with this displacement are. Reducing the doming displacement therefore increases image quality. FIG. 5 shows that the doming displacement is reduced from 38 μm for the standard magnet (line 51) to 21 μm for the 10% shunted magnet (temperature compensated) (line 52), i.e. a 45% reduction in doming, to 9 μm (temperature overcompensated) (line 53), i.e. a 75% reduction of doming. Thus, temperature compensation enables a substantial reduction of doming (line 52 in comparison with line 51), overcompensation an even more substantial reduction (line 53 in comparison with line 51).

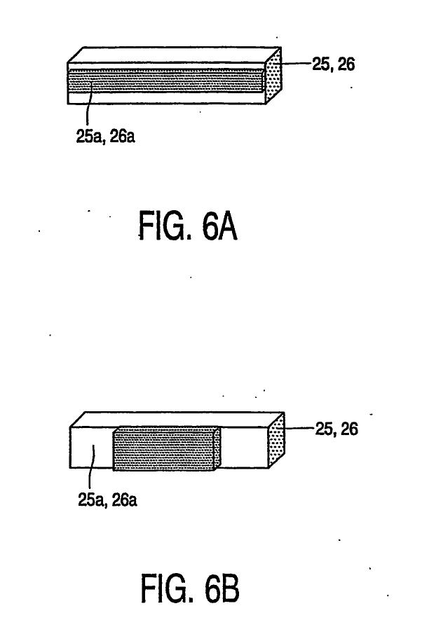

FIGS. 6A and 6B show schematically magnets 25, 26 with a shunt 25a, 26a In FIG. 6A the shunt 25a, 26a extends over the full length of the magnet 25, 26. This preserves the form of the original magnet field of magnets 25, 26, which is advantageous. In FIG. 6B, the shunt 25a, 26a extends over the full width of the magnet. The form of the magnet field is not preserved.

In short the invention can be described as follows:

A colour display device comprising a cathode ray tube and a deflection unit. The display device includes compensation magnets for correcting a raster distortion in the raster displayed on the screen. Said magnets (25, 26) comprise a shunt (25a, 26a) to increase the temperature coefficient of the permanent remanence. Preferably overcompensation occurs, i.e. the temperature coefficient is changed from a negative to a positive value.

While the invention has been described in connection with preferred embodiments, it will be understood that modifications thereof within the principles outlined above will be evident to those skilled in the art, and thus the invention is not limited to the preferred embodiments but is intended to encompass such modifications. Modifications include amongst others any and each combination of above described features and characteristics even if not explicitly described in the claims. Any reference signs do not limit the scope of the claims. The word “comprising” does not exclude the presence of elements other than those listed in a claim. The use of the word “a” or “an” preceding an element does not exclude the presence of a plurality of such elements.

1. A colour display device comprising a cathode ray tube comprising a display screen, a means for generating at least one electron beam and a deflection unit for generating deflection fields for deflecting electron beam(s) across the display screen in two perpendicular directions (x, y) and having magnetic field-generating means at or near a display screen-facing end of the deflection unit for generating a magnetic field to reduce raster distortions, characterized in that the permanent magnets are made of a material having a negative temperature coefficient for the magnetic remanence(B(G)), said magnets being provided with a compensating shunt to increase the temperature coefficient of the magnetic remanence.

2. A colour display device as claimed in claim 1, characterized in that the combination of magnet and shunt has a magnetic remanence which is substantially constant between room temperature and approximately 60° C.

3. A colour display device as claimed in claim 1, characterized in that the combination of magnet and shunt has a magnetic remanence which increases as the temperature increases from room temperature.

4. A colour display device as claimed in claim 3, characterized in that the magnetic remanence shows a maximum between 40 and 70° C.

5. A deflection unit for a display device having a cathode ray tube with a display screen a means for venerating at least one electron beam and a deflection unit for generating deflection fields for deflecting electron beam(s) across the display screen in two perpendicular directions (x, y) and having magnetic field-generating means at or near a display screen-facing end of the deflection unit for generating a magnetic field to reduce raster distortions, characterized in that the permanent magnets are made of a material having a negative temperature coefficient for the magnetic remanence (B(G)), said magnets being provided with a compensating shunt to increase the temperature coefficient of the magnetic remanence.

6. The deflection unit of claim 5, characterized in that the combination of magnet and shunt has a magnetic remanence which is substantially constant between room temperature and approximately 60° C.

7. The deflection unit of claim 5, characterized in that the combination of magnet and shunt has a magnetic remanence which increases as the temperature increases from room temperature.

8. The deflection unit of claim 7, characterized in that the magnetic remanence shows a maximum between 40 and 70° C.
